(19) United States
(12) Patent Application Publication
(10) Pub. No.: US 2023/0306343 A1
(43) Pub. Date: Sep. 28, 2023

(54) BUSINESS PROCESS MANAGEMENT SYSTEM AND METHOD THEREOF

(71) Applicants: Digiwin Software Co., Ltd, Shanghai (CN); DATA SYSTEMS CONSULTING CO., LTD., New Taipei City (TW)

(72) Inventors: Wenliang Bi, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 17/838,278

(22) Filed: Jun. 13, 2022

(30) Foreign Application Priority Data
Mar. 23, 2022 (CN) 202210287017.4

(51) Int. Cl. G06Q 10/06; G06Q 10/04

(52) U.S. Cl. CPC G06Q 10/0637; G06Q 10/0633; G06Q 10/04

(57) ABSTRACT

The disclosure provides a business process management system and a business process management system method. The business process management system includes a storage device and a processor. The storage device stores a data mining module, a path process matching module, and a process modeling optimization module. The processor executes multiple modules and obtains an enterprise system operating log. The processor executes the data mining module according to the enterprise system operation log to obtain a frequent path set including multiple event frequent paths. The processor inputs the frequent path set and multiple original business processes to the path process matching module, and executes the path process matching module to generate a matching path set matching the original business process. The processor executes the process modeling optimization module according to the frequent path set to generate a frequent path graph.

### CROSS-REFERENCE TO RELATED APPLICATION

This application claims the priority benefit of Chinese application serial no. 202210287017.4, filed on Mar. 23, 2022. The entirety of the above-mentioned patent application is hereby incorporated by reference herein and made a part of this specification.

### BACKGROUND

### Technical Field

The disclosure relates to a program system, in particular to a business process management system and a method thereof.

### Description of Related Art

With the development of enterprise systems and the data-based development of enterprise processes, the processes between systems and business processes have become more complex and diverse. Therefore, when the system performance of the enterprise system is abnormal or the business process is too time-consuming, it is difficult for managers to identify ways to improve the complex business processes and system processes and the reasons for the poor performance. As a result, it is not easy for users or managers to identify improvement guidelines and existing process problems from the complex business processes. Moreover, it is difficult for managers to add or develop new business processes in the process of complex interaction between systems. As a result, when business process efficiency is too low or when managers want to improve existing business processes, it is difficult to review and analyze existing business processes, resulting in low business efficiency and the inability to improve business processes based on existing operation data. In view of this, the following solutions are proposed for several embodiments.

### SUMMARY

The disclosure is directed to a business process management system and a method thereof, which may be used to provide reference information and recommendations to operators or managers for optimizing business processes according to enterprise system operation logs and original business processes.

According to an embodiment of the disclosure, the business process management system of the disclosure includes a storage device and a processor. The storage device stores multiple modules. The processor is coupled to the storage device. The processor executes multiple modules. The processor obtains an enterprise system operation log, and executes a data mining module according to the enterprise system operation log to obtain a frequent path set including multiple event frequent paths. The processor inputs the frequent path set and multiple original business processes to a path process matching module, and executes the path process matching module to generate a matching path set matching the original business process. The processor executes a process modeling optimization module according to the frequent path set to generate a frequent path graph.

According to an embodiment of the disclosure, the business process management method of the disclosure includes the following steps. An enterprise system operation log is obtained. A data mining module is executed according to the enterprise system operation log to obtain a frequent path set including multiple event frequent paths. A matching path set matching multiple original business processes is generated through a path process matching module according to the frequent path set and the original business processes. A frequent path graph is generated through a process modeling optimization module according to the frequent path set.

Based on the above, the business process management system and the method thereof of the disclosure automatically generates a matching path matching the original business process and each event information to build the frequent path graph according to the enterprise system operation log and the original business process.

To make the aforementioned more comprehensible, several accompanied with drawings are described in detail as follows.

### BRIEF DESCRIPTION OF THE DRAWING

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a business process management system according to an embodiment of the disclosure.

FIG. 2 is a flowchart of a method of a business process management system according to an embodiment of the disclosure.

FIG. 3 is a schematic diagram of a business process management system according to another embodiment of the disclosure.

FIG. 4 is a schematic diagram of a frequent path graph according to an embodiment of the present disclosure.

### DESCRIPTION OF THE EMBODIMENTS

Reference will now be made in detail to exemplary embodiments of the disclosure, examples of the exemplary embodiments being illustrated in the accompanying drawings. Wherever possible, the same component symbols are used in the drawings and descriptions to represent the same or similar parts.

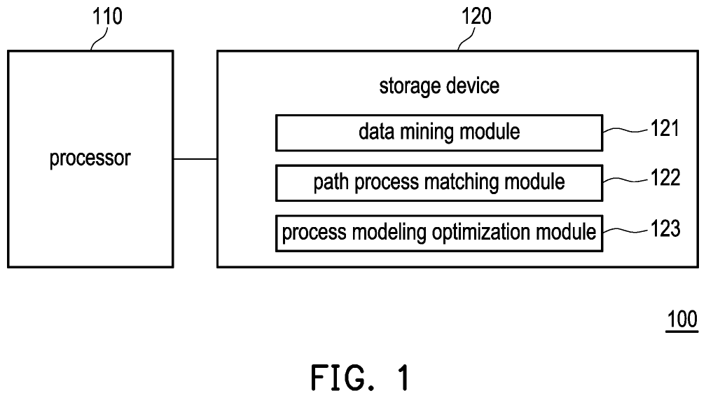

FIG. 1 is a schematic diagram of a business process management system according to an embodiment of the disclosure. Referring to FIG. 1, a business process management system 100 includes a processor 110 and a storage device 120. The processor 110 is coupled to the storage device 120. The storage device 120 stores a data mining module 121, a path process matching module 122, and a process modeling optimization module 123. In this embodiment, the business process management system 100 may be, for example, a computer host in the enterprise, or a computer host that communicates with the enterprise's database through wired or wireless means or through a network connection, to record and obtain an enterprise system operation log. In this embodiment, the business process management system 100 may also be implemented by a host computer or server host connected to (or communicating with) multiple computer hardware devices. The computer hardware devices may include, for example, a personal computer (PC), a workstation computer, a mobile computer, and a server computer, etc.

In this embodiment, the enterprise system operation log includes user behavior logs, transaction data, data footprints, system configuration data, system operation data, history data of data changes within the system, minimal event gateway logs, event occurrence timestamps, event associate customer code (Identify, ID), event name, event duration, request time, requester address, service name, service instance address assigned by the load balancer, status code, response time, and Hypertext Transfer Protocol (HTTP) proxy.

In this embodiment, the processor 110 may include, for example, a central processing unit (CPU), or other programmable general-purpose or special-purpose microprocessors, digital signal processors (DSP), application-specific integrated circuits (ASIC), programmable logic device (PLD), other similar processing circuits, or a combination of these devices. The storage device 120 may include a memory and/or a database. The memory may be, for example, a non-volatile memory (NVM). The storage device 120 may store relevant programs, modules, systems or algorithms for implementing various embodiments of the disclosure for the processor 110 to access and execute to implement the relevant functions and operations described in the embodiments of the disclosure. In this embodiment, the data mining module 121, the path process matching module 122, and the process modeling optimization module 123 may be implemented, for example, in a programming language such as JSON (JavaScript Object Notation), Extensible Markup Language (XML), or YAML, but the disclosure is not limited thereto.

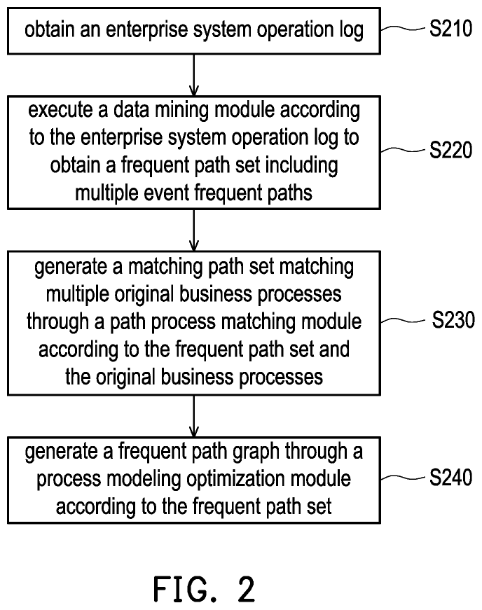

FIG. 2 is a flowchart of a method of a business process management system according to an embodiment of the disclosure. Referring to FIG. 1 and FIG. 2, the business process management system 100 may perform the following steps S210 to S240 to automatically provide reference information for the business process and automatically summarize a new path of an enterprise business process. In step S210, the processor 110 obtains the enterprise system operation log. In this embodiment, the enterprise system operation log (i.e., enterprise system operation data) are recorded through data buried point in the enterprise system. In this regard, the processor 110 communicates with the system database through wired or wireless means to obtain the enterprise system operation log. In step S220, the processor 110 executes the data mining module 121 according to the enterprise system operation log to obtain a frequent path set including multiple event frequent paths. In this embodiment, the data mining module 121 may perform data analysis and data mining of the enterprise system operation log to gather a list of associated events according to the enterprise system operation log to form a transaction set to be mined including multiple event chains. In this embodiment, the data mining module 121 generates the transaction set to be mined based on a method of depth-first search tree structure. Next, the data mining module 121 mines the frequent path set including multiple event frequent paths according to the transaction set to be mined. In this embodiment, the data mining module 121 extracts the event frequent path from the transaction set based on a mining algorithm.

In step S230, the processor 110 may generate a matching path set matching multiple original business processes through the path process matching module 122 according to the frequent path set and the original business processes. In this embodiment, the path process matching module 122 starts searching from a longest frequent path during path process matching. In this embodiment, the path process matching module 122 matches the event frequent path associated with the original business process in the frequent path set to generate the matching path set including multiple matching paths.

In this embodiment, multiple business processes in the original business process may respectively represent business behaviors and user operation behaviors performed by multiple computer hardware devices. In a specific embodiment, the original business process includes the host computer of the enterprise system operation log, the server host, user behavior logs, transaction data, data footprints, system configuration data, system operation data, history data of data changes within the system, minimal event gateway logs, event occurrence timestamps, event associate customer code (Identify, ID), event name, event duration, request time, requester address, service name, service instance address assigned by the load balancer, status code, response time, and Hypertext Transfer Protocol (HTTP) proxy operations and data.

In step S240, the processor 110 may generate a frequent path graph through the process modeling optimization module 123 according to the frequent path set. In this embodiment, the process modeling and optimization module 123 models the frequent path graph according to each path sequence element (e.g., each individual event) in the frequent path set as a node of the graph to generate the frequent path graph. In this embodiment, the process modeling and optimization module 123 indicates node information (i.e., node data) for each graph node (i.e., path node) on the frequent path graph, such as time consumption of each of the path node, path support.

In this way, the business process management system and the method thereof of the disclosure may automatically mine and match multiple event frequent paths associated with the original business process according to the enterprise system operation log, and may build the frequent path graph as marked according to the event nodes to automatically generate multiple call paths for building multiple application programming interface objects and application programming interfaces, and may automatically execute multiple application programming interface objects and application programming interfaces sequentially according to the call paths to automatically generate new business paths, and visualize the frequent path set to generate the frequent path graph.

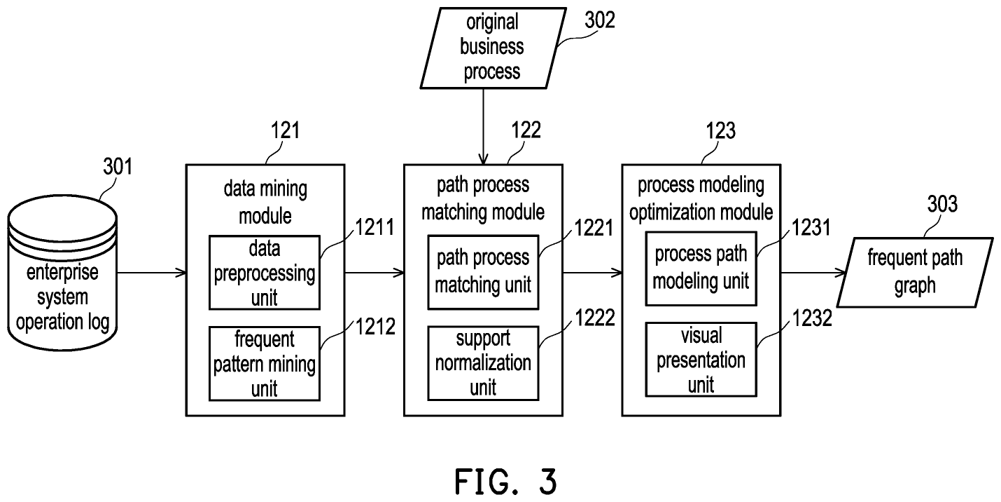

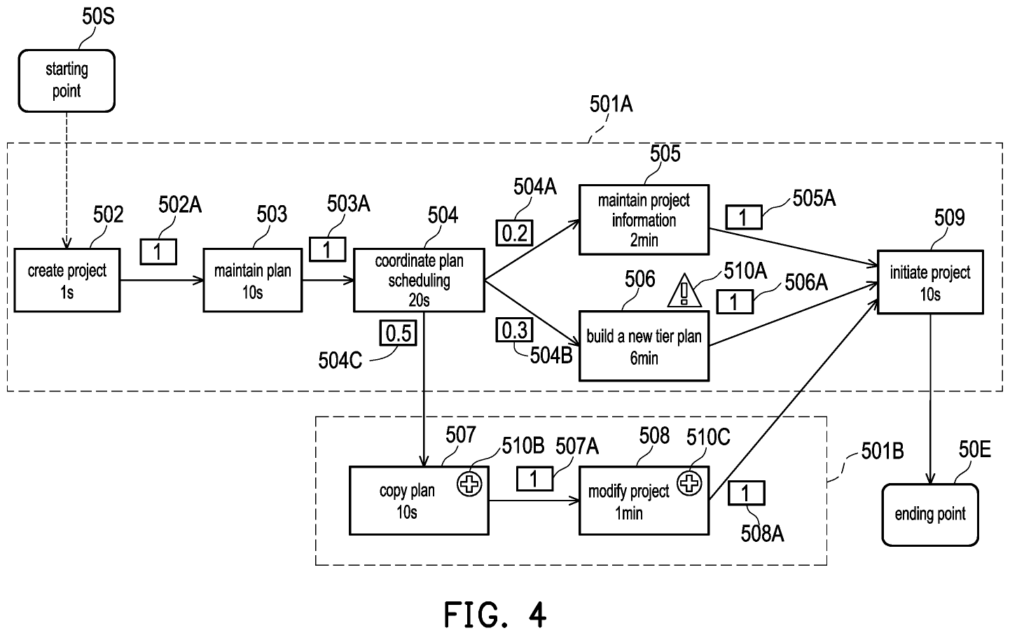

FIG. 3 is a schematic diagram of a business process management system according to another embodiment of the disclosure. FIG. 4 is a schematic diagram of a frequent path graph according to an embodiment of the present disclosure. Referring to FIG. 1 and FIG. 3, the data mining module 121 includes a data preprocessing unit 1211 and a frequent pattern mining unit 1212. The path process matching module 122 includes a path process matching unit 1221 and a support normalization unit 1222. The process modeling optimization module 123 includes a process path modeling unit 1231 and a visual presentation unit 1232. In this embodiment, the data preprocessing unit 1211 performs data cleaning and event chain generation according to the enterprise system operation log to generate a transaction set including multiple event chains, and the data preprocessing unit 1211 provides the transaction set to the frequent pattern mining unit 1212. In this embodiment, the data preprocessing unit 1211 performs the data cleaning process by eliminating error event records and system useless information from the enterprise system operation log, and then filtering out required field information to form a structured data set. For example, the required field information may be a request record in the gateway log with a successful response status code of 200 or 2xx, and the process of eliminating the error event records may be to eliminate the error event records with a status code of 4xx (e.g., 400, 404), and the disclosure is not limited thereto.

In this embodiment, the data preprocessing unit 1211 treats event chains with a same event starting point in the enterprise system operation log as the same event chain. Specifically, the data preprocessing unit 1211 identifies a request chain in the enterprise system operation log to form the starting point of an event occurrence chain. In this embodiment, the event chain and a starting node include user-occurring events from outside the system, system-automated events, and post-event events for process flow. Next, the data preprocessing unit 1211 aggregates the event chains with the same event starting point to generate the transaction set. In this embodiment, the data preprocessing unit 1211 may use a method based on a depth-first search tree structure to establish a transaction set.

Next, the frequent pattern mining unit 1212 performs frequent pattern mining according to the transaction set to generate the frequent path set. In this embodiment, the data mining module 121 executes different frequent pattern mining algorithms to generate the frequent path set according to different mining scenarios, such as algorithms for candidate set stitching, algorithms for trees, or algorithms for recursive suffixes. In this embodiment, a position of each event in the event chain (i.e., occurrence path) cannot be changed and exchanged during frequent pattern mining by the frequent pattern mining unit 1212. Specifically, the frequent pattern mining unit 1212 uses sequential pattern mining. In addition, the frequent path generated by the frequent pattern mining unit 1212 includes the most events. For example, for frequent paths that do not exist in the enterprise system operation log, as long as the number of frequencies reaches a threshold value, they are frequent paths. Specifically, the frequent pattern mining unit 1212 uses maximum frequent pattern mining (i.e., a path covering the most events).

For example, the processor 120 may execute the frequent pattern mining unit 1212 to generate the frequent path set including multiple event frequent paths according to, for example, Apriori algorithm framework design by the following definition: S={S₁, S₂, S₃, . . . , S_{z}} is an event set. Sequence Tᵢ={S₁, S₂, S₃, . . . , Sₖ} (0<k≤z) is an event chain path. k is a length of the occurrence path. O={T₁, T2, T3, . . . , Tn} is an event path set to be mined. Tisa set of all sub-paths of Tᵢ. For t∈T, c(t) denotes frequency of occurrence of t in O, i.e., the support of t. m is a frequency threshold (i.e., the minimum support). S₁, S₂, S₃ . . . , S_{Z} may be represented as individual events.

In this embodiment, the path process matching unit 1221 performs process matching and process augmentation according to the frequent path set and the original business process to generate the matching path set. In this embodiment, each of the frequent paths is matched to the original business process starting from the longest frequent path (i.e., including the most events) during the path process matching. Specifically, when the original business process accurately matches a frequent path in the frequent path set, the path process matching unit 1221 associates the frequent path to the original business process.

In another case, the path process matching unit 1221 associates a most supported or longest frequent path in frequent paths partially matching each other in the frequent path set and the original business process set to the relevant original business process for process matching to generate the matching path set including the most supported and/or longest length frequent path. Specifically, when the original business process is a sub-path of one or more frequent paths (i.e., the events of the original business process are the same as some of the events of the frequent paths), the path process matching unit 1221 associates the most supported frequent path (i.e., the highest frequency of occurrence) among all of the matched frequent paths to the original business process. And when one or more frequent paths are sub-paths of the original business process, the path process matching unit 1221 associates the largest frequent path among the frequent paths matching the principle business process to the original business process.

In another case, the path process matching unit 1221 uses a frequent path in the frequent path set not matched to the original business process set as an augmented business path for process augmentation to generate the matching path set including the augmented business path. Specifically, when any frequent path in the frequent path set does not match the original business process, that is, this frequent path belongs to a new business path, then the path process matching unit 1221 adds the business path to the original business process for business process augmentation. In another case, the path process matching unit 1221 determines the original business process not matched to the frequent path as infrequent (i.e., occurring less than a support threshold) and not associated with any frequent path.

Next, the path process matching unit 1221 provide the matching path set to the support normalization unit 1222, and the support normalization unit 1222 performs support normalization according to the matching path set and support of each path of the matching path set to generate the support after normalization. In this embodiment, the support normalization unit 1222 converts the support between each two events to a value in an interval from 0 to 1, and the support normalization unit may convert the support to an interval [(k−1)/kₘₐₓ,k/kₘₐₓ) using the equation Cu=(k−1+c/n)/kₘₐₓ. c is the frequency of p, n is the size of the transaction set (i.e., the number of events), cu is the support after normalization, and k is the length of the occurrence path.

In this embodiment, the process path modeling unit 1231 generates the frequent path graph according to the support after normalization and the matching path set, and the visual presentation unit 1232 generates the frequent path graph as marked according to the frequent path graph and the node data (e.g., support, event occurrence time, event duration) in the frequent path graph. In this embodiment, the process path modeling unit 1231 generates the frequent path graph (as shown in FIG. 4) according to each matching path in the matching path set, and the frequent path graph includes a frequent path 501A matching the original business process set. The frequent path 501A includes multiple events 502, 503, 504, 505, 506, 509, an event starting point 50S, and an event ending point 50E. Moreover, the frequent path graph also includes a new business process 501B in the frequent path set, and the new business process 501B includes multiple events 507, 508 and process prompt icons 510B, 510C.

In this embodiment, the visual presentation unit 1232 indicates data or information of each node (i.e., each event) of the path graph in the frequent path graph. In this embodiment, the visual presentation unit indicates multiple nodes of the frequent path graph with average duration of events according to duration of event in the enterprise system operation log to generate the frequent path graph as marked. Specifically, the visual presentation unit 1232 indicates the average duration of each event in the frequent path graph. Moreover, when the average duration of an event is greater than a time threshold (e.g., 2 minutes, 5 minutes) or the average duration of the remaining events, the visual presentation unit 1232 marks the event 506 with a greater duration with a warning icon 510A in the frequent path graph to provide a reference for the user to improve the process.

In this embodiment, the visual presentation unit 1232 generates multiple event support icons 502A, 503A, 504A, 505A, 506A, 507A, and 508A from adjacent event support, and marks the event support icons in the frequent path graph. Specifically, in the frequent path graph, when a number of lower nodes of a node is 1, the support icon of the node is set to 1 (as shown in 502A, 503A, 505A, 506A, 507A and 508A in FIG. 4). On the other hand, when the number of the lower nodes of a node is greater than 1, the support icon of the node is set according to the support of the lower nodes (as shown in 504A, 504B and 504C in FIG. 4), where a value of the support is greater than 0 and less than 1. In this way, users may quickly and clearly understand the status and information of the business processes according to the indication of the frequent path graph and visualized matching paths to improve the efficiency of users or business managers in reviewing and improving business processes.

To sum up, the business process management system and method thereof of the disclosure may automatically mine the largest and/or most frequent process path according to the enterprise system operation log and the original business process, and build the frequent path graph according to the matching path matching the original business process, the support of each event, and the duration of the event to provide reference information and recommendations to operators or managers for optimizing business processes, and to provide efficiency in process review and improvement according to visual information.

It will be apparent to those skilled in the art that various modifications and variations can be made to the disclosed without departing from the scope or spirit of the disclosure. In view of the foregoing, it is intended that the disclosure covers modifications and variations provided that they fall within the scope of the following claims and their equivalents.

What is claimed is:

1. A business process management system comprising:
a storage device storing a plurality of modules; and
a processor coupled to the storage device, and executing the modules,
wherein the processor obtains an enterprise system operation log, and executes a data mining module according to the enterprise system operation log to obtain a frequent path set comprising a plurality of event frequent paths,
wherein the processor inputs the frequent path set and a plurality of original business processes to a path process matching module, and executes the path process matching module to generate a matching path set matching the original business process,
wherein the processor executes a process modeling optimization module according to the frequent path set to generate a frequent path graph.

2. The business process management system according to claim 1, wherein the data mining module comprises a data preprocessing unit and a frequent pattern mining unit, and the data preprocessing unit performs data cleaning and event chain generation according to the enterprise system operation log to generate a transaction set comprising a plurality of event chains, and to provide the transaction set to the frequent pattern mining unit,
wherein the frequent pattern mining unit performs frequent pattern mining according to the transaction set to generate the frequent path set.

3. The business process management system according to claim 2, wherein the frequent pattern mining unit performs frequent pattern mining based on algorithms for candidate set stitching, algorithms for trees, or algorithms for recursive suffixes to generate the frequent path set.

4. The business process management system according to claim 2, wherein the data preprocessing unit treats event chains with a same event starting point in the enterprise system operation log as the same event chain to generate the transaction set comprising the event chain.

5. The business process management system according to claim 2, wherein the event chain comprises user-occurring events, system-automated events, and post-events for process flow.

6. The business process management system according to claim 1, wherein the path process matching module comprises a path process matching unit and a support normalization unit, and the path process matching unit performs process matching and process augmentation according to the frequent path set and the original business process to generate the matching path set, and to provide the matching path set to the support normalization unit,
wherein the support normalization unit performs support normalization according to the matching path set and support of each path of the matching path set to generate the support after normalization.

7. The business process management system according to claim 6, wherein the path process matching module uses a frequent path in the frequent path set not matched to the original business process set as an augmented business path for process augmentation to generate the matching path set comprising the augmented business path.

8. The business process management system according to claim 6, wherein the path process matching unit associates a most supported or longest frequent path in frequent paths partially matching each other in the frequent path set and the original business process set to the relevant original business process for process matching to generate the matching path set comprising the most supported and/or longest length frequent path.

9. The business process management system according to claim 1, wherein the process modeling optimization module comprises a process path modeling unit and a visual presentation unit, and the process path modeling unit generates the frequent path graph according to the support after normalization and the matching path set,
wherein the visual presentation unit generates the frequent path graph as marked according to the frequent path graph and node data in the frequent path graph.

10. The business process management system according to claim 9, wherein the visual presentation unit indicates a plurality of nodes of the frequent path graph with average duration of events according to duration of event in the enterprise system operation log to generate the frequent path graph as marked.

11. A business process management method comprising:
obtaining an enterprise system operation log;
executing a data mining module according to the enterprise system operation log to obtain a frequent path set comprising a plurality of event frequent paths;
generating a matching path set matching a plurality of original business processes through a path process matching module according to the frequent path set and the original business processes; and
generating a frequent path graph through a process modeling optimization module according to the frequent path set.

12. The business process management method according to claim 11, wherein to obtain the frequent path set comprising the event frequent paths comprises:
generating a transaction set comprising a plurality of event chains through a data preprocessing unit configured to perform data cleaning and event chain generation;
generating the frequent path set through a frequent pattern mining unit configured to perform frequent pattern mining.

13. The business process management method according to claim 12, wherein the frequent pattern mining unit performs frequent pattern mining based on algorithms for candidate set stitching, algorithms for trees, or algorithms for recursive suffixes to generate the frequent path set.

14. The business process management method according to claim 12, wherein generating the transaction set comprising the event chains comprises:
generating the transaction set comprising the event chains through the data preprocessing unit treating event chains with a same event starting point in the enterprise system operation log as the same event chain.

15. The business process management system according to claim 12, wherein the event chain comprises user-occurring events, system-automated events, and post-events for process flow.

16. The business process management method according to claim 11, wherein generating the matching path set matching the original business processes comprises:
generating the matching path set through a path process matching unit configured to perform process matching and process augmentation;
generating support after normalization through a support normalization unit configured to perform support normalization.

17. The business process management method according to claim 16, wherein generating the matching path set comprises:
generating the matching path set comprising an augmented business path through the path process matching unit using a frequent path in the frequent path set not matched to the original business process set as the augmented business path for process augmentation.

18. The business process management method according to claim 16, wherein generating the matching path set comprises:
generating the matching path set comprising a most supported and/or longest length frequent path through the path process matching unit associating the most supported or longest frequent path in frequent paths partially matching each other in the frequent path set and the original business process set to the relevant original business process for process matching.

19. The business process management method according to claim 11, wherein generating the frequent path graph comprises:
generating the frequent path graph through a process path modeling unit according to support after normalization and the matching path set;
generating the frequent path graph as marked through a visual presentation unit according to the frequent path graph and node data in the frequent path graph.

20. The business process management method according to claim 19, wherein generating the frequent path graph as marked comprises:
generating the frequent path graph as marked through the visual presentation unit indicating a plurality of nodes of the frequent path graph with average duration of events.
